(19) United States
(12) Patent Application Publication
(10) Pub. No.: US 2009/0278678 A1
(43) Pub. Date: Nov. 12, 2009

(54) Braking and Acceleration Psychomotor Indicator of Vehicles

(76) Inventor: Aleksei Borisovich Krotkov, Moscow (RU)

Correspondence Address: FRISHAUF, HOLTZ, GOODMAN & CHICK, PC, 220 Fifth Avenue, 16TH Floor, NEW YORK, NY, 10001-7708, US

(21) Appl. No.: 12/084,524

(22) PCT Filed: Oct. 5, 2006
(86) PCT No.: PCT/RU2006/000519

§ 371 Date: May 1, 2008

(30) Foreign Application Priority Data
Nov. 1, 2005 (RU) 2005133578

(51) Int. Cl. B60Q 1/50

(52) U.S. Cl. 340/467; 340/479

(57) ABSTRACT

The invention can be used to increase the comfort and safety of road traffic by using a more appropriate notification of braking and acceleration of transport vehicles. According to the invention, the indicator includes an acceleration speed (a kick) sensor, a switch and one or more groups of sources of electric light. During the braking, the kick sensor emits a signal to the switch in order to switch the braking indication lamps so as to create a visual effect of lights running in all directions; the more intense braking is, and the more marked is this visual effect. In this manner, it is possible to imitate the increase of visible (angular) dimensions of transport vehicles, which are perceived very quickly by a human eye. In a similar way, during the acceleration of the transport vehicle the acceleration indication lights are switched so as to create an effect of lights approaching each other. The device is autonomous, does not require any connection to the systems of the transport vehicle and can be mounted in any transport vehicle thanks to its independent case, universal fixings and its own electric supply.

Utility model belongs to land transport technology, in particular, to light devices of traffic safety, to classification group B60Q 1/44.

Such light devices as adaptive stop-lights are well-known. Their brightness and effective area are proportionate to the braking rate of a vehicle (invention application No. 94039643/11) and, particularly, stop-light “Running lights”, representing the row of light diodes, which at pressing the braking pedal realizes, as it was said in the description, “alternating infill of the row—accumulating of lights” (http://domavto.narod.ru).

Indicated devices have following disadvantages:
Inadequate stop-lights activation relative to true braking of a vehicle. Frequently, incomplete pressing on pedal brake, causing stop-lights activation, doesn't lead to the braking of a vehicle. And on the contrary, when a driver doesn't use pedal brake, for instance, at engine braking or at breakage incident a vehicle brakes without engaging of stop-lights. A great part of false activations prevent a driver from confiding in stop-lights but they still make a driver divert his attention from situation on the road. Therein lies possible danger of stop-lights. Stop-lights of “running light” type distracts attention even to a greater extent, that is why they introduce only drivers' irritation (from this the name “auto toy” comes). In itself the principle of “running light” is used only for drawing attention due to its mobility and flickering but in no way for imitating of visible sizes change of a vehicle. It follows neither from descriptions nor from analysis of carrying samples functioning. As for adaptive stop-lights they also don't solve the problem since degree of brightness or area can't be estimated by a driver quickly and fairly enough.
Indication of start from motionless and acceleration of a vehicle is absent, though it could enhance safety and comfort of traffic, in particular due to accurate observance of distance during movement in condensed transport streams.

The aim of the present useful model is to provide more adequate and reliable notification of road traffic participants about braking, (start from motionless) and acceleration of a vehicle.

Aforesaid purpose is achieved by means of braking and acceleration psychomotor indicator, furnished with gauge of speed of acceleration change (gauge of jerk), power supply and two or more groups of light sources of different colors.

The gauge of speed of acceleration (gauge of jerk) is applied in suggested indicator inasmuch as the only information, that exert favorable influence on safety of traffic, is the information which is necessary at the moment of potential hazard and such is the moment of braking or (breakdown) acceleration increase of a vehicle, i.e. the very moment of its jerk. The rest of information is superfluous and hence harmful as it overloads drivers' attention and drowns useful information in its torrent. Even the usage of accelerometers would give out a lot of false signals, since during uniform motion of a vehicle down the slope, the longitudinal component of gravitational acceleration vector arises and accelerometer defines it as negative acceleration (braking), and defines it as acceleration at uniform movement “uphill”.

As regards the usage of standard stop-lights one could only say that in condensed transport streams they divert driver's attention almost continually. Stop-lights of “running light” type distract attention even more skillfully. In much the same way so called “adaptive” stop-lights are perceived, as their brightness and effective area expand proportionally to deceleration: at sharp braking a driver has no time to evaluate and has nothing to compare with how bright or wide the stop-lights of a vehicle moving ahead flash. Moreover various makes of vehicles differ sometimes considerably from one another in brightness and area.

As a result participants of road traffic have to measure the braking jerk value of a car ahead “by eye”, namely according to visible (angular) sizes increase of a car ahead. Such method is absolutely reliable but not quick enough and it often causes collisions and discomfort during movement in streams of vehicles. That is why the following signaling principle is suggested as a solution:
notification signals should be given out at the very moment of braking (acceleration) jerk occurrence;
intensity of notification signal should be proportional to jerk value;
signal of breaking notification should correspond to the principle of natural perception with human eye of image of approaching to a vehicle ahead. Signal lights should imitate increase of visible sizes of a vehicle for this purpose they should create effect of of a distance (according to “running light” type) and increasing of its own sizes. A driver in conformity with psychomotor peculiarities of perception will react to such light effects at reflex level and therefore quickly;
At braking jerk cessation the braking notification signal should continue to shine for some time besides the stronger breaking jerk was the longer the signal should last. It is associated with possible switching of human attention from a vehicle ahead to other objects (for example, he can shift his gaze to the dash-board for a short time);
For more comfortable traffic in streams of vehicles the light signal can be also given out at acceleration jerk occurrence by scheme analogical with breaking, but by means of another color and with signal lights approaching effect.

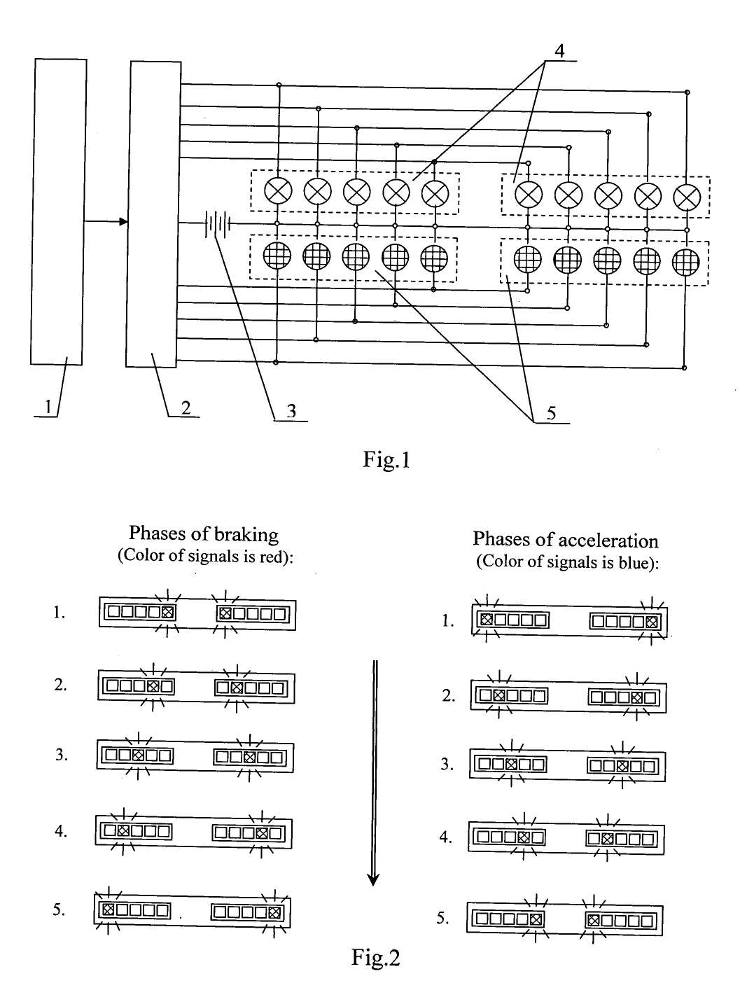

FIG. 1 shows the scheme of braking and acceleration psychomotor indicator.

The indicator includes the gauge of speed of acceleration change (gauge of jerk) 1, a switchboard 2, a source of power supply 3, groups of electrical light sources 4 for braking indication of a vehicle (the sources are red), groups of electrical light sources 5 for acceleration indication of a vehicle (it can be light sources in blue color).

FIG. 2 shows the scheme of signal light switching at braking and acceleration of a vehicle. The device functions as follows.

When braking jerk of the vehicle occurs, gauge of speed of acceleration change (jerk) 1 gives out the signal to switchboard 2, and the last one, according to jerk value, turns on and switches braking indication lights 4 so that the effect a distance of lights and their visible size (or brightness) increasing is created. The more intensively braking, the more quickly and on greater distance move lights. The device functions in much the same way when acceleration jerk arises, switchboard, depending on jerk value, turns on and switches acceleration indication lights 5 in such a way as to form effect of lights approach and their visible size (or brightness) decrease. The more intensive acceleration is, the quicker lights should “approach”. The device is totally “all-sufficient”, i.e. it doesn't need connection to any vehicle systems and owing to independent frame, universal fastenings and autonomous power supply can be installed in any vehicle.

1-2. (canceled)

3. A braking and acceleration psychomotor indicator of vehicles comprising light sources, switching devices, gauges of speed, and acceleration change (gauges of jerk) of a vehicle, a switchboard, and one or more groups of light sources, wherein the switchboard and groups of light sources create an effect of two or more lights for imitating both increase of visible (angular) sizes of a vehicle at its braking, and decrease of visible (angular) sizes of a vehicle at its acceleration.

4. The braking and acceleration indicator in accordance with claim 1, wherein the switchboard alternately turns on and off corresponding light sources (or sections) but does not turn them off immediately after a signal is provided from the gauges of speed and acceleration change in order to provide delay which guarantees perception, fixed according to the time or proportional to the rate of the signal gauge.

5. The braking and acceleration indicator in accordance with claim 1, wherein the activation of the gauges of speed and acceleration change signals functions as a power supply for the switchboard and for light sources at the same time.

6. The braking and acceleration indicator in accordance with claim 1, further comprising a power supply and autonomous performance within the frame with fastening mechanisms to elements of various vehicles.

7. The braking and acceleration indicator in accordance with claim 2, wherein the activation of the gauges of speed and acceleration change signals functions as a power supply for the switchboard and for light sources at the same time.

8. The braking and acceleration indicator in accordance with claim 2, further comprising a power supply and autonomous performance within the frame with fastening mechanisms to elements of various vehicles.
